(19) United States
(12) Patent Application Publication
(10) Pub. No.: US 2009/0109097 A1
(43) Pub. Date: Apr. 30, 2009

(54) MULTIPLE FREQUENCY BAND ANTENNA

(75) Inventors: Huang-Tse Peng, Taipei County (TW); Kuo-Jen Lai, Taipei County (TW)

Correspondence Address: KIRTON AND MCCONKIE, 60 EAST SOUTH TEMPLE,, SUITE 1800, SALT LAKE CITY, UT, 84111, US

(73) Assignee: ARIMA COMMUNICATIONS CO., LTD., Taipei County (TW)

(21) Appl. No.: 11/923,256

(22) Filed: Oct. 24, 2007

(51) Int. Cl. H01Q 9/04

(52) U.S. Cl. 343/700 MS

(57) ABSTRACT

A multiple frequency band antenna for a wireless communication device includes a first radiating element, a connecting element and a second radiating element. The connecting element has an end connected to the first radiating element and includes a feeding point and a ground terminal. The second radiating element has a first terminal connected to the other end of the connecting element and a second terminal externally extended and bent for several time. The second radiating element is externally extended in the direction substantially parallel with the connecting element and has a longer path length compared with the first radiating element. The first radiating element is configured to transmit and receive wireless signals in multiple first frequency bands. The second radiating element is configured to transmit and receive wireless signals in multiple second frequency bands. The frequencies of the first frequency bands are higher than those of the second frequency bands.

### FIELD OF THE INVENTION

The present invention relates to an antenna, and more particularly to a multiple frequency band antenna for use in a wireless communication device.

### BACKGROUND OF THE INVENTION

In recent years, the development of the wireless communication industry is vigorous. The wireless communication devices, for example, cell phones or PDAs, have become indispensable commodities for people. An antenna generally plays an important role for transmitting and receiving wireless signals in a wireless communication device. Therefore, the operating characteristics of the antenna have a direct impact on the transmission and receiving quality for the wireless communication device.

Generally, the antenna of the portable wireless device is roughly classified into two categories, including the external type antenna and embedded type antenna. The external type antenna is commonly shaped as a helical antenna, and the embedded type antenna is commonly shaped as a planar inverted-F antenna (PIFA). The helical antenna is exposed to the exterior of the casing of the wireless communication device and is prone to be damaged. Thus, the helical antenna usually bears a poor communication quality. A planar inverted-F antenna has a simple structure and a small size and is easily to be integrated with electronic circuits. Nowadays, planar inverted-F antenna has been widely employed in a variety of electronic devices.

Typically, a well-designed antenna is required to have a low return loss and a high operating bandwidth. In order to allow the user of the wireless communication device to receive wireless signals with great convenience and high quality, the current wireless communication devices have been enhanced by increasing the number of antennas or enlarge the antenna to allow the wireless communication device to transmit and receive wireless signals with a larger bandwidth or multiple frequency bands. However, with the integration of circuit elements and the miniaturization of the wireless communication device, the conventional design method has been outdated.

For allowing the wireless communication device to increase the number of antennas in the limited receiving space so as to transmit and receive wireless signals with a larger bandwidth and a better transmission quality and performance, the structure of the antenna has been modified. Referring to FIG. 1, the structure of a conventional multiple frequency band antenna is shown. As shown in FIG. 1, the conventional multiple frequency band antenna 1 is made up of a planar inverted-F antenna, which includes a first radiating element 11, a second radiating element 12, and a parasitic element 13. Moreover, a feeding point 14 and a first ground terminal 15 are disposed at one side of the distal region of the second radiating element 12, and a second ground terminal 16 is disposed at one side of the distal region of the parasitic element 13. The distal region of the first radiating element 11 and the distal region of the second radiating element 12 are connected with each other, and the parasitic element 13 is separated from the first radiating element 11 and the second radiating element 12 and approximate to the first radiating element 11. The multiple frequency band antenna 1 is adapted for dual frequency band applications, where the low frequency band is the frequency band located at 880˜960 MHz of the GSM (Global System for Mobile Communications) system, and the high frequency band is the frequency band located at 1920˜2170 MHz of the WCDMA (Wideband Code Division Multiple Access) system.

Please refer to FIG. 1 again. The feeding point 14 can feed the RF signals to be transmitted by RF circuits (not shown) to the multiple frequency band antenna 1. Certainly, the feeding point 14 can feed the RF signal sensed by the multiple frequency band antenna 1 to the RF circuits. The first radiating element 11 is shaped like a right hand square bracket “]” and has a longer path length compared with the second radiating element 12, thereby forming a resonant mode to transmit and receive wireless signals in a low frequency band located at, for example, 880˜960 MHz of GSM system. The second radiating element 12 is shaped like the character “L”, and the linear segments of the second radiating element 12 that are not connected with the first radiating element 11 are located in the gap between two opposing linear segments of the first radiating element 11. Consequently, the second radiating element 12 has a shorter path length compared with the first radiating element 11, and thus the second radiating element 12 can form a resonant mode to transmit and receive wireless signals in a high frequency band located at, for example, 1920˜2170 MHz of the WCDMA system. The parasitic element 13 is configured to increase the bandwidth of the high frequency band.

Referring to FIG. 2, the standing-wave ratio versus frequency relationship of the multiple frequency band antenna of FIG. 1 is shown. As shown in FIG. 2, the longitudinal axis represents the standing-wave ratio (SWR) of the multiple frequency band antenna 1 that shows a linear relationship with the gain value of the return loss. In addition, the standing-wave ratio can be converted into the gain value of the return loss through computations. It is noted that the standing-wave ratio will vary with the frequency. Generally, if the antenna 1 has a standing-wave ratio below 3 under a frequency band, it indicates that the antenna performs well under that frequency band. Hence, it can be understood from FIG. 2 that the multiple frequency band antenna 1 of FIG. 1 is adapted for the low frequency band located at 880˜960 MHz of the GSM system, and for the high-frequency band located at 1920˜2170 MHz of the WCDMA system.

In addition to the aforementioned antenna 1, the Taiwanese Patent Application No. 092119341 entitled “multiple frequency band antenna for cell phone” also discloses another antenna structure for use with dual frequency band applications, where the low frequency band is located at the frequency band of the GSM system and the high frequency band is located at the frequency band of personal communication services (PCS) system. However, the contemporary wireless communication system not only supports the GSM system, but also supports the digital communication system (DCS) system, personal communication services (PCS) system, and the WCDMA system. The frequency bands of the DCS system, the frequency bands of the PCS system and the frequency bands of the WCDMA system are located at 1710˜1880 MHz, 1850˜1990 MHz, and 1920˜2170 MHz, respectively. Because the conventional antenna is only adapted for single frequency band application or dual frequency band applications, it is obvious that the limited frequency bandwidth of the conventional antenna can not be adapted for the code division multiple access (CDMA) system, the GSM system, the DCS system, the PCS system, and the WCDMA system simultaneously.

Therefore, there is a need of developing a multiple frequency band antenna with a larger frequency bandwidth for obviating the drawbacks encountered by the prior art.

### SUMMARY OF THE INVENTION

An object of the present invention is to provide a multiple frequency band antenna having a plurality of radiating elements, a common feeding point and a common ground terminal for increasing the bandwidth of the antenna. The multiple frequency band antenna of the present invention is adapted for global system for the code division multiple access (CDMA) system, the mobile communication (GSM) system, the digital communication system (DCS), the personal communication system (PCS), and the wideband code division multiple access (WCDMA) system.

Another object of the present invention is to provide a multiple frequency band antenna that can increase its bandwidth with reduced dimension and size of the antenna, thereby improving the efficiency of antenna and reducing the power consumption of antenna.

In accordance with an aspect of the present invention, there is provided a multiple frequency band antenna for a wireless communication device. The multiple frequency band antenna includes a first radiating element, a connecting element and a second radiating element. The connecting element has an end connected to the first radiating element and includes a feeding point and a ground terminal. The second radiating element has a first terminal connected to the other end of the connecting element and a second terminal externally extended and bent for several time. The second radiating element is externally extended in the direction substantially parallel with the connecting element and has a longer path length compared with the first radiating element. The first radiating element is configured to transmit and receive wireless signals in multiple first frequency bands. The second radiating element is configured to transmit and receive wireless signals in multiple second frequency bands. The frequencies of the first frequency bands are higher than those of the second frequency bands.

In an embodiment, the first frequency bands include the frequency band of the digital communication (DCS) system, the frequency band of the personal communication services (PCS) system, and the frequency band of the wideband code division multiple access (WCDMA) system.

In an embodiment, the second frequency bands includes the frequency band of the code division multiple access (CDMA) system and the frequency band of the global system for mobile communications (GSM) system.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a plan view showing the structure of a conventional multiple frequency band antenna;

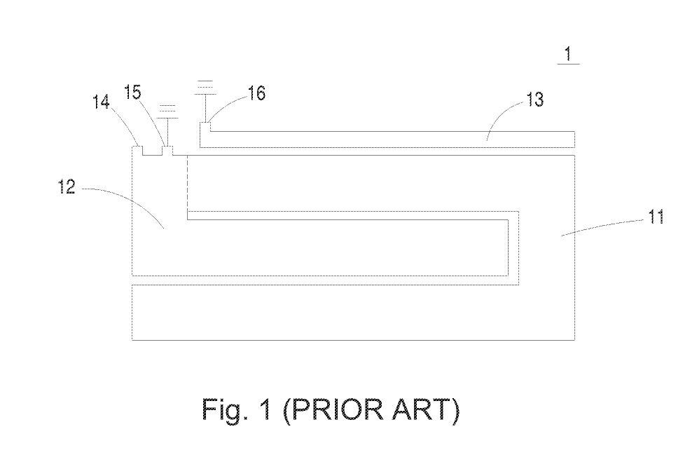

FIG. 2 is a characteristic plot showing the standing-wave ratio versus frequency relationship of the multiple frequency band antenna;

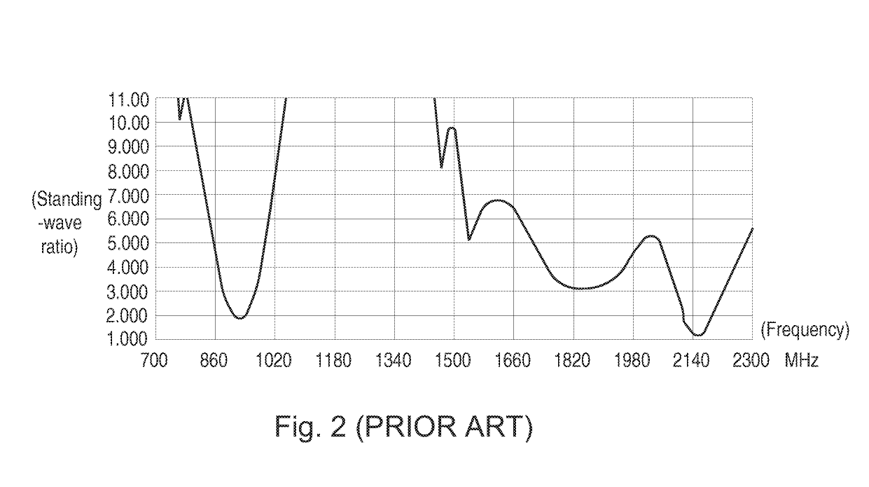

FIG. 3(a) is a plan view showing the structure of a multiple frequency band antenna according to a preferred embodiment of the present invention;

FIG. 3(b) is a plan view showing the structure of a multiple frequency band antenna according to another preferred embodiment of the present invention;

FIG. 4 is a compilation showing the comparison between the standing-wave ratio versus the frequency relationship of the multiple frequency band antenna of FIG. 1 and the standing-wave ratio versus the frequency relationship of the multiple frequency band antenna of FIG. 3; and

FIG. 5 is a compilation showing the comparison between the performance versus the frequency relationship of the multiple frequency band antenna of FIG. 1 and the performance versus the frequency relationship of the multiple frequency band antenna of FIG. 3.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

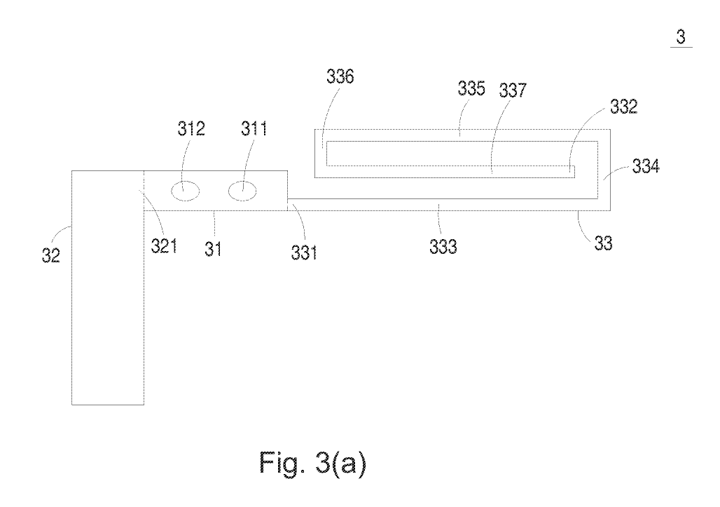

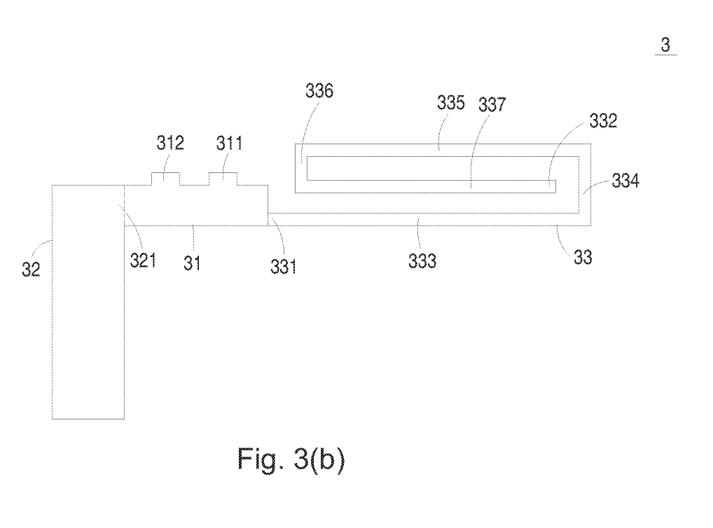

Referring to FIG. 3(a), a schematic view of a multiple frequency band antenna according to a preferred embodiment of the present invention is shown. As indicated in FIG. 3(a), the multiple frequency band antenna 3 of the present invention includes a connecting element 31, a first radiating element 32 and a second radiating element 33. The multiple frequency band antenna 3 can be mounted on a flexible printed circuit board (FPCB) (not shown). Due to the flexibility of the flexible printed circuit board, the multiple frequency band antenna 3 can be securely mounted in the receiving space inside the casing of a wireless communication device without the need of bending the inner wall of the receiving space.

Please refer to FIG. 3(a) again. The connecting element 31 includes a feeding point 311 and a ground terminal 312. The feeding point 311 and the ground terminal 312 are formed as holes and arranged at the middle regions of the connecting element 31. Alternatively, as shown in FIG. 3(b), the feeding point 311 and the ground terminal 312 are formed as conductive sheets and arranged at one side of the connecting element 31. It is preferred that the width of the connecting element 31 is for example but not limited to 4 mm. Moreover, one end of the connecting element 31 is connected to one side of the distal region 321 of the first radiating element 32. The first radiating element 32 and the connecting element 31 are cooperatively shaped like the character “L”. The other end of the connecting element 31 is connected to a first terminal 331 of the second radiating element 33. Consequently, the RF signals to be issued are transmitted to the first radiating element 32 and the second radiating element 33 through both ends of the connecting element 31. Alternatively, the RF signals received by the first radiating element 32 and the second radiating element 33 are transmitted to the connecting element 31 through both ends of the connecting element 31.

The width of the first radiating element 32 is for example but not limited to 6 mm. One side of the distal region 321 of the first radiating element 32 is connected to the connecting element 31. The width of the connecting element 31 is smaller than that of the first radiating element 32. In addition, the width of the second radiating element 33 is smaller than that of the connecting element 31. In this embodiment, the width of the second radiating element 33 is for example but not limited to 2 mm. The first terminal 331 of the second radiating element 33 is connected to the connecting element 31. The second terminal 332 of the second radiating element 33 is externally extended in the direction substantially parallel with the connecting element 31. In some embodiments, the second radiating element 33 is bent for several times such that the overall area of the multiple frequency band antenna 3 is reduced. For example, as shown in FIG. 3(a), the second radiating element 33 is bent for four times. Consequently, from the first terminal 331 to the second terminal 332, the second radiating element 33 successively includes a first extension part 333, a first turning part 334, a second extension part 335, a second turning part 336 and a third extension part 337. The first extension part 333, the second extension part 335 and the third extension part 337 are parallel with the connecting element 31. The interval between the first extension part 333 and the third extension part 337 or the interval between the second extension part 335 and the third extension part 337 is for example but not limited to 2 mm. The first turning part 334 and the second turning part 336 are substantially perpendicular to the connecting element 31.

According to the present invention, the feeding point 311 can feed the RF signals to be transmitted by RF circuits (not shown) to the multiple frequency band antenna 3. Certainly, the feeding point 311 can feed the RF signal sensed by the multiple frequency band antenna 3 to the RF circuits. The first radiating element 32 has a shorter path length compared with the second radiating element 33, thereby forming a resonant mode to transmit and receive wireless signals in a first frequency band (e.g. a relatively higher frequency band). In this embodiment, the first frequency band is located at the frequency band of a digital communication system (DCS) system, a personal communication services (PCS) system, and a WCDMA system. The frequency bands of the DCS system, the frequency bands of the PCS system and the frequency bands of the WCDMA system are located at 1710˜1880 MHz, 1850˜1990 MHz, and 1920˜2170 MHz, respectively. Whereas, the second radiating element 33 forms a resonant mode to transmit and receive wireless signals in a second frequency band (e.g. a relatively lower frequency band). Moreover, the first radiating element 32 may broaden the second frequency band. The second frequency band includes multiple relatively lower frequency bands located at 880˜960 MHz of the GSM system or 824˜880 MHz of a code division multiple access (CDMA) system.

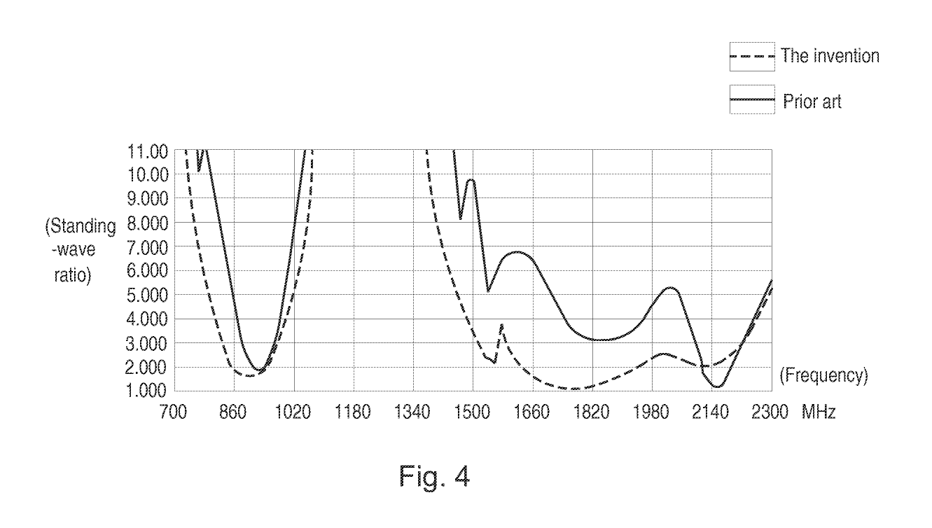

Referring to FIG. 4, the comparison between the standing-wave ratio versus frequency relationship of the multiple frequency band antenna of FIG. 3 and the standing-wave ratio versus frequency relationship of the conventional multiple frequency band antenna is depicted. As shown in FIG. 4, the longitude axis represents the standing-wave ratio of the multiple frequency band antenna that shows a linear relationship with the gain value of the return loss and can be converted into the gain value of the return loss through computations. It is noted that the standing-wave ratio will vary with the frequency. Generally, if the antenna has a standing-wave ratio below 3 under a frequency band, it indicates that the antenna performs well under that frequency band. Hence, it can be understood from FIG. 4 that the conventional antenna 1 is adapted for dual frequency band application where the low frequency band is located at 880˜960 MHz of GSM system and the high frequency band is located at 1920˜2170 MHz of WCDMA system. However, the multiple frequency band antenna of the present invention is adapter for the low frequency band located at 880˜960 MHz of the GSM system or at 824˜880 MHz of the CDMA system. Moreover, the multiple frequency band antenna of the present invention can increase the bandwidth of the high frequency band so that it can be adapted for DCS system, PCS system, and WCDMA system.

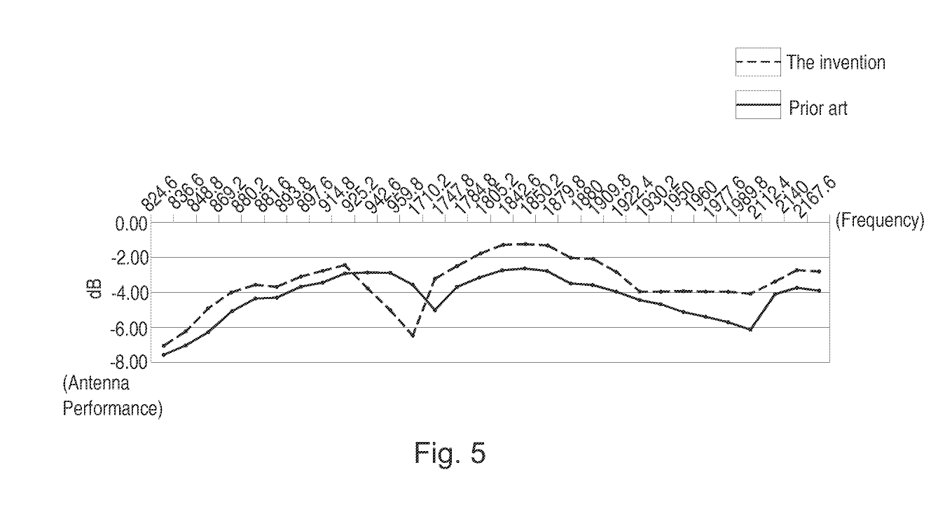

Referring to FIG. 5, the comparison between the antenna performance versus frequency relationship of the multiple frequency band antenna of FIG. 3 and the antenna performance versus frequency relationship of the conventional multiple frequency band antenna is depicted. As shown in FIG. 5, in the low frequency band located at 880˜960 MHz of the GSM system or 824˜880 MHz of the CDMA system, the multiple frequency band antenna 3 of the present invention has better performance compared with the conventional multiple frequency band antenna 1. However, in the high frequency band located at the frequency band of DCS system, the frequency band of PCS system, or the frequency band of WCDMA system, the multiple frequency band antenna 3 of the present invention can attain a better performance and lower power consumption compared with the conventional multiple frequency band antenna 1.

Table 1 shows the comparison between the multiple frequency band antenna of FIG. 3 and the conventional multiple frequency band antenna in terms of performance and physical characteristics. It can be understood from table 1 that the multiple frequency band antenna 3 of the present invention has a broader bandwidth to be adapted for more frequency band applications. As a consequence, the multiple frequency band antenna of the present invention can attain a good performance in the frequency bands of the CDMA system, the DCS system, the PCS system and the WCDMA system. In other words, the use of the conventional multiple frequency band antenna fails to attain the performance of the multiple frequency band antenna of the present invention. Besides, the volume and size of the multiple frequency band antenna 3 of the present invention are substantially reduced when compared with the conventional multiple frequency band antenna. Therefore, the multiple frequency band antenna 3 of the present invention may be further developed toward minimization in its structure. As previously described, the conventional multiple frequency band antenna requires one or more feeding points and two or more ground terminals. Whereas, the multiple frequency band antenna of the present invention only requires a common feeding point and a common ground terminal, thereby simplifying the structure of the antenna.

TABLE 1
The performance and physical characteristic of the conventional
multiple frequency band antenna and the multiple frequency
band antenna of the present invention

| | | | | | | Physical | |
|---|---|---|---|---|---|---|---|
| | Performance | | | | | Characteristics | |
| | CDMA | GSM | DCS | PCS | WCDMA | Size | Joints |
| Prior | Poor | Good | Poor | Poor | Fair | The same | 3 |
| Art | | | | | | | |
| The | Good | Good | Good | Good | Good | Smaller | 2 |
| Invention | | | | | | | |

In conclusion, the present invention provides a multiple frequency band antenna by configuring and connecting a plurality of radiating elements and a common feeding point and a common ground terminal, so as to increase the bandwidth of the antenna. Thus, the multiple frequency band antenna of the present invention can be applied to the CDMA system, the GSM system, the DCS system, the PCS system and the WCDMA system simultaneously. On the other hand, the multiple frequency band antenna of the present invention can increase the bandwidth of the antenna, improve the antenna efficiency, reduce the power consumption of the antenna with reduced dimension and size of the antenna.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A multiple frequency band antenna for a wireless communication device comprising:
a first radiating element;
a connecting element having an end connected to said first radiating element and including a feeding point and a ground terminal; and
a second radiating element having a first terminal connected to the other end of said connecting element and a second terminal externally extended and bent for several time, wherein said second radiating element is externally extended in the direction substantially parallel with said connecting element and has a longer path length compared with said first radiating element, wherein the width of said first terminal of said second radiating element is less than that of said connecting element;
wherein said first radiating element is configured to transmit and receive wireless signals in multiple first frequency bands, and said second radiating element is configured to transmit and receive wireless signals in multiple second frequency bands, the frequencies of said first frequency bands being higher than those of said second frequency bands.

2. The multiple frequency band antenna according to claim 1 wherein said first frequency bands include the frequency band of the digital communication (DCS) system, the frequency band of the personal communication services (PCS) system, and the frequency band of the wideband code division multiple access (WCDMA) system.

3. The multiple frequency band antenna according to claim 1 wherein said second frequency bands includes the frequency band of the code division multiple access (CDMA) system and the frequency band of the global system for mobile communications (GSM) system.

4. The multiple frequency band antenna according to claim 1 wherein said multiple frequency band antenna is mounted on a flexible printed circuit board.

5. The multiple frequency band antenna according to claim 1 wherein one side of a distal region of said first radiating element is connected to said connecting element, and said first radiating element and said connecting element are cooperatively shaped like the character “L”.

6. The multiple frequency band antenna according to claim 1 wherein the width of said first radiating element is greater than that of said connecting element.

7. The multiple frequency band antenna according to claim 1 wherein said second radiating element successively includes a first extension part, a first turning part, a second extension part, a second turning part and a third extension part from said first terminal to said second terminal.

8. The multiple frequency band antenna according to claim 7 wherein said first extension part, said second extension part and said third extension part of said second radiating element are substantially parallel with said connecting element.

9. The multiple frequency band antenna according to claim 7 wherein said first turning part and said second turning part are substantially perpendicular to said connecting element.

10. (canceled)

11. The multiple frequency band antenna according to claim 1 wherein said feeding point and said ground terminal are formed as holes and arranged at the middle regions of said connecting element.

12. The multiple frequency band antenna according to claim 1 wherein said feeding point and said ground terminal are formed as conductive sheets and arranged at one side of said connecting element.
